(19) United States
(12) Patent Application Publication
(10) Pub. No.: US 2023/0124560 A1
(43) Pub. Date: Apr. 20, 2023

(54) CELL SWELLING RESTRAINT WITH HEAT STAKED FIXATION

(71) Applicants: CPS Technology Holdings LLC, New York, NY (US); Clarios Advanced Solutions GmbH, Hannover (DE)

(72) Inventors: Nicholas E. Elison, Mequon, WI (US); Eric Kar Wai Lee, Antioch, IL (US); Jordan Petrie, Wauwatosa, WI (US); Dale B. Trester, West Allis, WI (US); Marco Jansen, Celle (DE); Joerg Birkholz, Sarstedt (DE)

(21) Appl. No.: 17/794,480

(22) PCT Filed: Jan. 22, 2021
(86) PCT No.: PCT/US2021/014550

§ 371 Date: Jul. 21, 2022

Related U.S. Application Data
(60) Provisional application No. 62/964,463, filed on Jan. 22, 2020.

(51) Int. Cl. H01M 50/242; H01M 50/293; H01M 10/655

(52) U.S. Cl. CPC H01M 50/242; H01M 50/293; H01M 10/655; H01M 50/209

(57) ABSTRACT

A battery module is described herein. The example battery module incldues a housing, a pluarlity of battery cells, and at least one cell-swelling restraint feature. The example cell-swelling restraint feature includes a cradle, side walls, and heat-staking features. The example battery module also includes an isolation feature positioned between the restraint feature and the battery cells to provide electrical insulation.

### CROSS-REFERENCE TO RELATED APPLICATIONS

This application claims the benefit of U.S. Provisional Patent Application No. 62/964,463, filed Jan. 22, 2020, entitled “CELL SWELLING RESTRAINT WITH HEAT STAKED FIXATION,” the entire content of which is hereby incorporated by reference herein in its entirety.

### BACKGROUND

The disclosure relates generally to the field of batteries and battery modules. More specifically, the disclosure relates to a housing for a battery or battery module.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle uses one or more battery systems. In particular, a vehicle (e.g., an electric vehicle, a hybrid vehicle) may use a lithium-ion (Li-ion) battery in place of or in addition to a more traditional lead-acid battery. As will be appreciated by those skilled in the art, hybrid electric vehicles (HEVs), also considered EVs, combine an internal combustion engine propulsion system and a battery-powered electric propulsion system, such as 48 Volt (V) or 130V systems. In some electric vehicles, the lithium-ion battery supplies a majority of or all of the power used to propel the vehicle. Some hybrid electric vehicles may recover braking energy through a belt or crank integrated starter generator. This energy is stored in the lithium-ion battery cells. Thus, the lithium-ion battery are also used to store re-claimed energy while the vehicle is in use, in addition to storing a typical charge collected from another power source (e.g., an AC power source) while the car is not in use.

Many design aspects are considered when using a lithium-ion battery. For example, it may be beneficial for a lithium-ion battery to fit in a similar space as a lead-acid battery. Additional design considerations may include weight, crush-resistance, heat transfer from the lithium-ion cells to prevent overheating, materials cost, cost of manufacturing, and ease of manufacturing. Because different sizes, capacities, or types of lithium-ion batteries may be used for different vehicle applications, designing a battery system that can be used with a wide variety of vehicles (and in non-vehicular applications) may be advantageous to increase an ease of manufacturing for a line of lithium-ion battery systems.

As technology continues to evolve, there is a need to provide improved power sources, particularly battery modules, for such vehicles.

### SUMMARY

A battery system and method are accordingly disclosed. Summaries of various aspects are set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below. The present disclosure relates to batteries and battery modules. More specifically, the present disclosure relates to lithium-ion battery cells that may be used in vehicles as well as other energy storage/expending applications (e.g., energy storage for an electrical grid).

The disclosure relates to a battery module including a housing having a restraint feature with heat-staking features. The battery module also includes a battery cell assembly disposed within an interior space of the housing. The housing also includes an isolation feature positioned between the restraint feature and the battery cells to electrically insulate the battery cells from the restraint feature. metal base plate that functions as a heat sink to draw heat away from the cell assembly. The metal base plate can be coupled to the plastic portion of the housing using an adhesive dispensed in a groove of the housing.

The disclosure also relates to a method for manufacturing a battery module. The method includes positioning the restraint feature in the housing, positioning an adhesive on a bottom surface of the restraint feature, inserting the isolation feature on within the restraint feature, and then inserting the battery cell assembly.

### BRIEF DESCRIPTION OF THE DRAWINGS

Various examples of embodiments of the systems, devices, and methods according to this invention will be described in detail, with reference to the following figures.

FIG. 1 is a perspective view of a vehicle having a battery system contributing all or a portion of the power for the vehicle, in accordance with an embodiment of the application.

FIG. 2 is a cutaway schematic view of the vehicle of FIG. 1, in the form of a hybrid electric vehicle (HEV) having a battery module.

FIG. 3 is an isometric view of an example battery module used in FIG. 2.

FIG. 4 is an isometric view of a portion of the battery module of FIG. 3 with a housing wall removed and with a restraint feature.

FIG. 5 is a partial exploded view of the portion of the battery module of FIG. 4.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF THE DRAWINGS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (e.g., EVs) and other high voltage energy storage/expending applications (e.g., electrical grid power storage systems). Such battery systems may include one or more battery modules, each battery module having a housing and a number of battery cells (e.g., Lithium-ion (Li-ion) electrochemical cells) arranged within the housing to provide particular voltages and/or currents useful to power, for example, one or more components of a vehicle. As another example, battery modules in accordance with present embodiments may be incorporated with or provide power to stationary power systems (e.g., non-automotive systems).

Present embodiments include physical battery module features, assembly components, manufacturing and assembling techniques, and so forth, that facilitate the manufacture of battery modules and systems in a manner that may enable a wider tolerance of battery cell dimensions, a wider degree of variability within that tolerance, and a potential reduction in size and weight of the battery modules and systems. Indeed, using the approaches described herein, it may be possible to design certain advanced battery modules (e.g., Li-ion battery modules) to have a desired form factor.

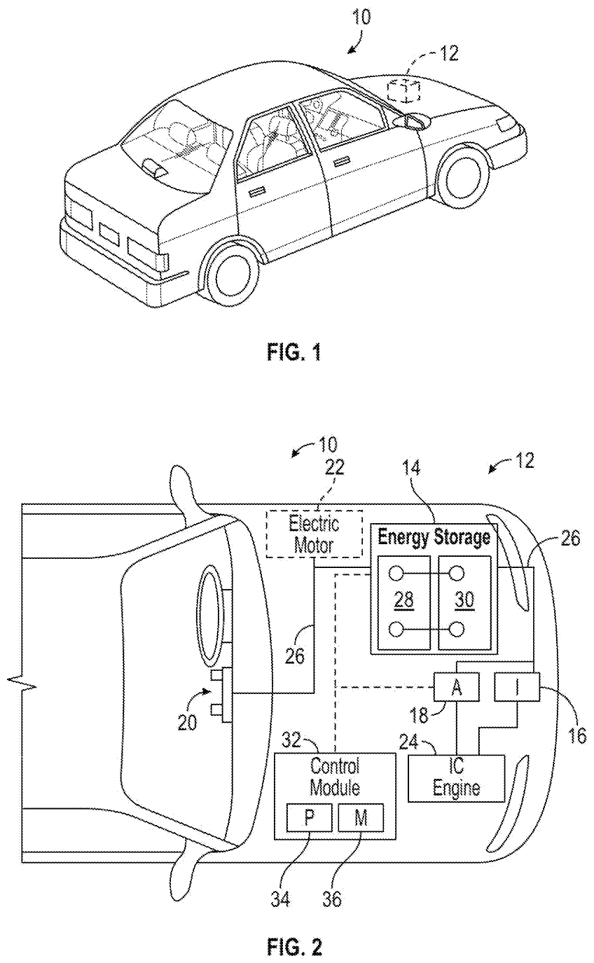

Again, the battery modules configured in accordance with present embodiments may be employed in any number of energy expending systems (e.g., vehicular contexts, such as electric-powered vehicles, gas-powered vehicles, and stationary power contexts, such as commercial applications, electric power grids, generators, etc.). To facilitate discussion, constructions of the battery modules described herein are presented in the context of advanced battery modules employed in vehicles (e.g., xEVs). With the foregoing in mind, FIG. 1 is a perspective view of such a vehicle 10, which may utilize a regenerative braking system. As used herein, the terms “battery” and “battery module” may be interchangeable.

It may be desirable for a battery system 12 to be largely compatible with traditional vehicle designs. For example, as illustrated, the vehicle 10 may include the battery system 12 positioned similar to a lead-acid battery of a typical combustion-engine vehicle (e.g., under the hood of the vehicle 10).

A more detailed view of a battery system 12 is described in FIG. 2. As depicted, the battery system 12 includes an energy storage component 14. The energy storage component is coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

The battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof In the depicted construction, the energy storage component 14 supplies power to the vehicle console 20 and the ignition system 16, which may be used to start (e.g., crank) the internal combustion engine 24.

Additionally, the energy storage component 14 may capture electrical energy generated by the alternator 18 and/or the electric motor 22. In some implementations, the alternator 18 generates electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 can generate electrical energy by converting mechanical energy produced by the movement of the vehicle 10 (e.g., rotation of the wheels) into electrical energy. Thus, the energy storage component 14 may capture electrical energy generated by the alternator 18 and/or the electric motor 22 acting as a generator during regenerative braking. As such, the electric motor 22 is generally referred to herein as a regenerative braking system.

To facilitate capturing and supplying electric energy, the energy storage component 14 may be electrically coupled to the vehicle's electric system via a bus 26. For example, the bus 26 enables the energy storage component 14 to receive electrical energy generated by the alternator 18 and/or the electric motor 22. Additionally, the bus 26 may enable the energy storage component 14 to output electrical energy to the ignition system 16 and/or the vehicle console 20. Accordingly, when a 12 Volt (V) battery system 12 is used, the bus 26 may carry electrical power typically between 8-18 volts.

Additionally, as depicted, the energy storage component 14 includes multiple battery modules. For example, in the depicted embodiment, the energy storage component 14 includes a lithium-ion (e.g., a first) battery module 28 and a lead-acid (e.g., a second) battery module 30, which each includes one or more battery cells 31. In other constructions, the energy storage component 14 includes any number of battery modules. Additionally, although the lithium-ion battery module 28 and lead-acid battery module 30 are depicted adjacent to one another, they may be positioned in different areas around the vehicle. For example, the lead-acid battery module may be positioned in or about the interior of the vehicle 10 while the lithium-ion battery module 28 may be positioned under the hood of the vehicle 10.

In some implementations, the energy storage component 14 includes multiple battery modules to utilize multiple different battery chemistries. For example, when the lithium-ion battery module 28 is used, performance of the battery system 12 may be improved since the lithium-ion battery chemistry generally has a. higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 additionally includes a control module 32. More specifically, the control module 32 may control operations of components in the battery system 12, such as relays switches) within the energy storage component 14, the alternator 18, and/or the electric motor 22. The control module 32 may regulate the amount of electrical energy captured/supplied by each battery module 28 or 30 (e.g., to de-rate and re-rate the battery system 12), perform load balancing between the battery modules 28 and 30, determine a state of charge of each battery module 28 or 30, determine temperature of each battery module 28 or 30, control voltage output by the alternator 18 and/or the electric motor 22, and the like.

As shown in FIG. 2, the control module 32 includes one or more processors 34 and one or more memories 36. More specifically, the one or more processors 34 may include one or more application-specific integrated circuits (ASICs), one or more field-programmable gate arrays (FPGAs), one or more general purpose processors, or any combination thereof. Additionally, the one or more memories 36 may include volatile memory, such as random-access memory (RAM), and/or non-volatile memory, such as read-only memory (ROM), optical drives, hard disc drives, or solid-state drives. In some embodiments, the control module 32 may include portions of a vehicle control unit (VCU) and/or a separate battery control module. Furthermore, as depicted, the lithium-ion battery module 28 and the lead-acid battery module 30 are connected in parallel across their terminals. In other words, the lithium-ion battery module 28 and the lead-acid module 30 may be coupled in parallel to the vehicle's electrical system via the bus 26.

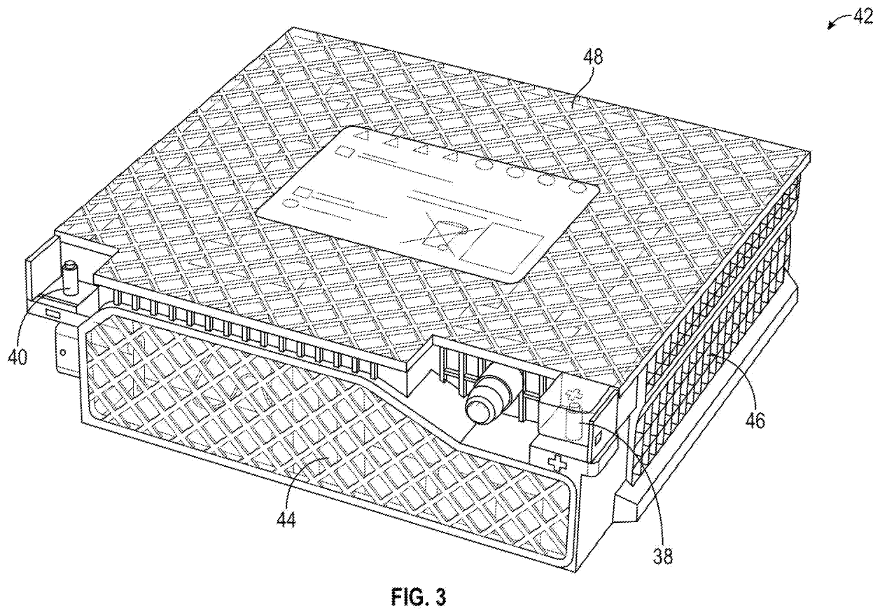

Thee lithium-ion battery modules 28 may have any one of a variety of different shapes, sizes, output voltages, capacities, and so forth, and the present disclosure is generally intended to apply to different variations of the shapes and sizes of the modules illustrated in the figures. Keeping this in mind, FIG. 3 is a front top perspective view of one construction of the battery module 28.

The battery module 28 includes a first terminal 38 (e.g., a negative terminal) and a second terminal 40 (e.g., a positive terminal) that may be coupled to an electrical load (e.g., circuit). In other constructions, the battery module has more than two terminals, to provide different voltages for different loads via connections across different terminal combinations.

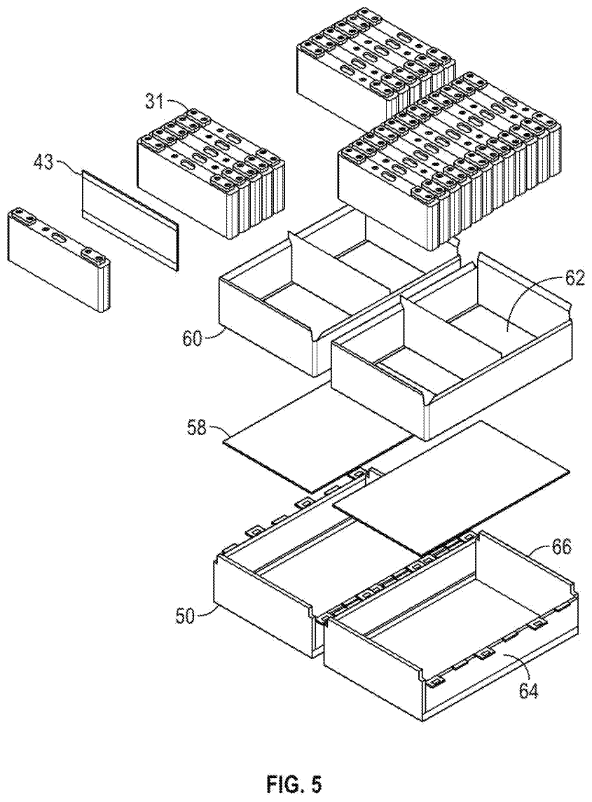

FIG. 3 depicts an example construction of the lithium-ion battery module 28. The battery module 28 includes a housing 42 for packaging or containing a plurality of battery cells 31 and other components of the battery module. The battery cells 31 may be separated from one another by a separator 43 (see FIG. 5). As will be described in more detail below, the housing 42 packages a plurality of prismatic battery cells 31. The housing 42 includes two end portions 44, two side portions 46, a top portion 48 (e.g., fitted with a top cover), and a bottom portion (not shown). FIG. 3 shows the top portion 48, one of the two end portions 44, and one of the two side portions 46. The housing may also include one or more dividing walls which divide the battery cells. The housing 42 may be polymeric (e.g., polypropylene, acrylonitrile butadiene styrene (ABS), a polystyrene (PS), a polyimide (PI), or another suitable polymer or plastic or combination thereof), or other suitable housing material or combination of materials.

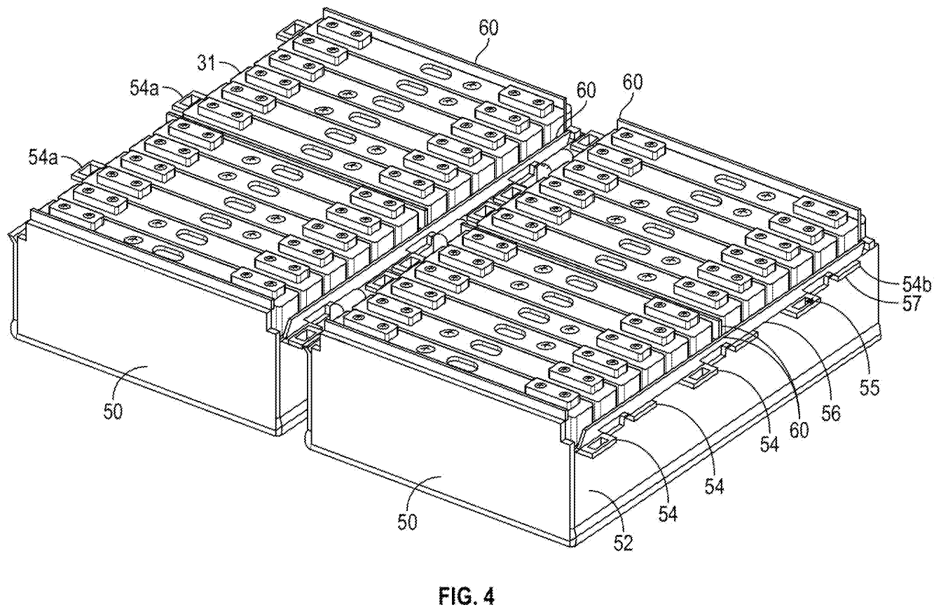

FIG. 4 is an isometric view of a battery module 28 of FIG. 3 without the housing 42 so that a pair of restraint, features 50 is shown. Referring to FIG. 4, a plurality of cells 31 can be seen within an example embodiment of the restraint feature 50. This restraint feature 50 may be understood as able to fit within the battery housing 42 having a cover 48. Furthermore, a battery management system and electrical components (not shown) may be coupled to the cells for example, provided on top of the cells.

As can be seen in FIG. 4, the restraint feature 50 surrounds one or more groupings of cells 31. This restraint feature 50 aids in providing sufficient constraint against swelling for battery cells 31 contained within the battery housing 42. The thickness of each wall 52 of the restraint feature 50 may vary. Further, the restraint feature 50 may advantageously act as a heat sink. A heat sink may be understood as a feature which draws heat away from the battery cell or cells 31. The cell swelling restraint feature 50 can be an aluminum structure that is staked inside battery housing 42. The cell swelling restraint feature 50 and assembly physically constrains the cells 31 to optimize cell performance. The disclosed may also constrain the cells 31 in the event of thermal runaway. In various embodiments, the restraint feature 50 can withstand the pressure force caused by cell expansion. Additionally, the disclosed structure of the restraint feature 50 may draw the heat away from the cells 31 and out of the battery module 28 to reduce internal temperatures. The disclosed restraint feature 50 may have further advantages to heat dissipation, allowing for heat shedding on a bottom face of the shelf and also indirectly on the sides of the cells 31 and the front and back.

In the illustrated example, the restraint feature comprises heat-staking 54 features (e.g., tabs) at a top 56 of each wall 52 for heat-staking one or more posts within the housing. The heat-staking features 54 may be integrally formed with the restraint feature 50. The depicted heat-staking features 54 are substantially rectangular. The heat-staking 54 features include a first portion 54a and a second portion 54b that act as connecting tabs. The first portion of the heat-staking feature 54, which is positioned on a first restraint features 50, may interlock with a corresponding second portion of the heat-staking feature 54, which is positioned on a second restraint feature 50. The first heat-staking portion 54a includes an opening 55 and the second portion 54b includes a protrusion 57. The protrusion 57 is sized to correspond with a size of the opening 55 so that the connection between the first and second portions 54a, 54b of each interlocking-heat-staking feature 54 are secured. The heat-staking features 54 are sized to handle the mechanical and thermal loads the battery module 30 is expected to see over its lifetime. The protrusion 57 and the corresponding opening 55 of the heat-staking feature 54 have corresponding shapes and are shaped in such a way to facilitate automatic alignment of the parts as they are assembled, even if the initial placement of the restraint feature 50 within the housing 42 is not perfect. The heat-staking features 54 are advantageous over other fasteners because as the heat-staking features 54 are formed to account for tolerances in overall height, whereas other types of fasteners, such as snaps, tend to not have adjustability. In some examples, similar heat-staking features 54 may be included on the housing 42 so that the restraint feature 50 (e.g., an aluminum tray) is secured within the housing 42. Heat-staking may provide for advantages over known connection mechanisms, allowing for secure connection across axis of movement while advantageously not using fasteners. It is preferable to avoid the use of fasteners because use of fasteners may introduce further features into the housing which may pose a risk to cell damage.

FIG. 5 shows an exploded view of the battery module 28 having the cell swelling restraint feature 50 of FIG. 4. The restraint feature 50 (e.g., cell swelling restraint feature) may be constructed of a suitable material that may be metal, such as but not limited to, aluminum. The aluminum may advantageously adhere via an adhesive, for example, an epoxy, 58 to the housing 42. An isolation feature 60 may be provided between the cell swelling restraint feature 50 and the cells 31. The isolation feature 60 is positioned atop the adhesive layer 58. The isolation feature 60 may have a hole 62 in the bottom which exposes the adhesive 58 to a base of the cells 31 (i.e., allows the adhesive 58 to contact the cells 31 to secure the cells within the housing 42). The isolation feature 60 may advantageously provide electrical insulation between the cells 31 and the restraint feature 50, which also acts as a heat sink. The adhesive layer 58 may fixate the cells 31 to the restraint feature 50 and may have sufficient thermal conductivity to draw heat to the restraint feature 50 so that it may act as a heat sink. Additionally, the restraint feature 50 includes a U-shaped cradle 64 as well as two end walls 66 to capture both sides of cell stack. Thus, the restraint feature 50 may provide more structure than a plain drawn piece of aluminum.

A method for providing the mechanism for cell-swelling restraint (e.g., the restraint feature 50) may also be understood to be disclosed. In various embodiments, a plastic U-shaped sheet with the large hole in the bottom is placed inside the cell swelling restraint structure 50. Adhesive 58 is placed in the hole 62 and the cells 31 are positioned atop the adhesive 58 and isolation feature (60). The cell swelling restraint feature 50 may then be heat-staked into the housing 42 via the heat-staking features 54. A busbar carrier (not shown) may be affixed to the top of the aluminum structure instead of the housing 42.

One or more of the disclosed embodiments, alone or in combination, may provide one or more technical effects including the manufacture of battery modules having battery cells (e.g., prismatic battery cells). The disclosed designs enable the use of stacks of battery cells that may be placed within a housing of the battery module and that may be maintained below a maximum operating temperature using a heat sink. Accordingly, the disclosed battery module designs may offer improved flexibility and performance compared to other battery module designs. The technical effects and technical problems in the specification are exemplary and are not limiting. It should be noted that the embodiments described in the specification may have other technical effects and can solve other technical problems.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A cell-swelling restraint feature for a battery housing comprising:
a cradle;
side walls; and
heat-staking features positioned on a top of the side walls, the heat staking features securing the cell-swelling restraint feature in the battery housing. (Original) The cell-swelling restraint feature of claim 1, wherein a material of the cell-swelling restraint feature includes metal.

3. The cell-swelling restraint feature of claim 1, wherein a material of the cell-swelling restraint feature includes aluminum.

4. The cell-swelling, restraint feature of claim 1, wherein the cradle is substantially U-shaped.

5. A battery module, comprising:
a battery housing;
a plurality plurality of battery cells; and
a cell-swelling restraint feature of claim 1.

6. The battery module of claim 5 further including an isolation feature to provide electrical insulation between the battery cells and the cell-swelling restraint feature.

7. The battery module of claim 5 further including an adhesive layer to couple the plurality of battery cells to the cell-swelling restraint feature,

8. The battery module of claim 6, wherein the isolation feature surrounds the plurality of battery cells.

9. (canceled)

10. The battery module of claim 5, wherein the cell-swelling restraint features is a heat sink.

11. The battery module of claim 5 further comprising a second plurality of battery cells and a second cell-swelling restraint feature, wherein the second cell-swelling restraint feature is substantially identical to the cell-swelling restraint feature, wherein the two cell-swelling restraint features are positioned side-by-side in the battery housing.

12. A battery module, comprising:
a battery housing;
a plurality of battery cells; and
a cell-swelling restraint feature having a cradle, side walls, and heat-staking features positioned on a top of the side walls, the heat-staking features comprising first and second interlocking portions, wherein the heat staking features secure the cell-swelling restraint feature in the battery housing.

13. The battery module of one of claim 12 further including an isolation feature to provide electrical insulation between the battery cells and the cell-swelling restraint feature.

14. The battery module of claim 12 further including an adhesive layer to couple the plurality of battery cells to the cell-swelling restraint feature,

15. The battery module of claim 13, wherein the isolation feature surrounds the plurality of battery cells.

16. (canceled)

17. The battery module of claim 12, wherein the cell-swelling restraint feature is a heat sink.

18. The battery module of claim 12 further comprising a second plurality of battery cells and a second cell-swelling restraint feature, wherein the second cell-swelling restraint feature is substantially identical to the cell-swelling restraint feature, wherein the two cell-swelling restraint features are positioned side-by-side in the battery housing.

19. The battery module of claim 18, wherein the heat-staking features of the first cell-swelling restraint feature interlock with the heat-staking features of the second cell-swelling restraint feature.

20. The battery module of claim 12, wherein the first portion of the cell-swelling restraint feature includes an opening and the second portion of the cell-swelling restraint feature includes a protrusion.
